(19) United States
(12) Patent Application Publication
(10) Pub. No.: US 2023/0032797 A1
(43) Pub. Date: Feb. 2, 2023

(54) TICKET SWITCHING BETWEEN ATTENDEES DURING AN EVENT

(71) Applicant: AP LABS, LLC, Oyster Bay, NY (US)

(72) Inventors: Jason Scott Apfel, Oyster Bay, NY (US); Eric Jon Apfel, Syosset, NY (US)

(21) Appl. No.: 17/392,171

(22) Filed: Aug. 2, 2021

(51) Int. Cl. G06Q 20/04; G06Q 10/02; G06K 9/00

(52) U.S. Cl. CPC G06Q 20/0457; G06Q 10/02; G06K 9/00456; G06K 2209/01

(57) ABSTRACT

Methods, systems, and apparatus, including computer programs encoded on a computer storage medium, for switching tickets between attendees during an event. The method may include the actions of receiving ticket information from multiple users attending an event, determining that tickets for a particular section are held by one or more of the multiple users, providing a switch offer to the particular user to switch a ticket of the particular user with a ticket held by one of the one or more of the multiple users, receiving a switch request for the switch offer, providing switch offers to each of the one or more of the multiple users, receiving an acceptance of the switch offer from a first user of the one or more of the multiple users, and providing an instruction to cancel the switch offers to other users of one or more of the multiple users.

### FIELD

This specification relates to ticket handling, and one particular implementation relates to switching tickets between attendees during an event.

### BACKGROUND

People may use mobile computing devices to purchase tickets to events. For example, a person may browse a website and order tickets to a baseball game. When people later enter venues where events are being held, they may display their tickets on their mobile computing devices to enter the venues. For example, a person may present, on their mobile computing device, a barcode of a ticket for an usher to scan.

### SUMMARY

This document describes techniques, methods, systems, and other mechanisms for switching tickets during an event. A server switches the tickets between attendees of the event while the event is ongoing. For example, the tickets may be switched between two attendees at the end of the 7^{th} inning of the baseball game or at the end of the third quarter of a football game. The server receives tickets from the attendees, determines whether to provide offers to switch (also referred to as “switch offers”) to various attendees, and provides switched tickets to attendees. The switch offers may be for any ticket in a particular section instead of specific tickets identified by row and/or seat number.

Particular implementations can, in certain instances, realize one or more of the following advantages. For example, determining whether to provide switch offers that are even switches or upgrades instead of providing all switch offers, including downgrades, may reduce network bandwidth usage for transmitting fewer switch offers. In another example, reducing switch offers may result in decreased power consumption as users will interact with a mobile computing device less in reviewing switch offers. In yet another example, providing requests for tickets in sections may provide a more user friendly experience than requesting specific tickets as users at an event may be limited to using a mobile computing device with a small display and have difficulty viewing and selecting from tens or hundreds of individual tickets.

One innovative aspect of the subject matter described in this specification is embodied in methods that include the actions of receiving ticket information from multiple users attending an event, the ticket information including information from a particular user, determining, based on the ticket information, that tickets for a particular section are held by one or more of the multiple users, the one or more multiple users being different from the particular user, providing a switch offer to the particular user to switch a ticket of the particular user with a ticket held by one of the one or more of the multiple users in the particular section, receiving a switch request for the switch offer from the particular user, providing switch offers to each of the one or more of the multiple users in the particular section to switch with the particular user, receiving an acceptance of the switch offer from a first user of the one or more of the multiple users in the particular section, and providing an instruction to cancel the switch offers to other users of one or more of the multiple users in the particular section.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. For instance, in some aspects, determining, based on the ticket information, that tickets for a particular section are held by one or more of the multiple users, the one or more users being different from the particular user includes determining from the ticket information from the first user that the first user holds a first ticket for the particular section and determining from the ticket information from a second user that the second user holds a second ticket for the particular section.

In certain aspects, determining from the ticket information from the first user that the first user holds a first ticket for the particular section includes determining the particular section from optical character recognition on an image of the first ticket. In some implementations, determining from the ticket information from the first user that the first user holds a first ticket for the particular section includes determining the particular section from textual input from the first user that specifies the particular section. In some aspects, providing a switch offer to the particular user to switch a ticket of the particular user with a ticket held by one of the one or more of the multiple users in the particular section includes determining a section of the ticket of the particular user and determining whether to provide the switch offer to the particular user based on both the section of the ticket of the particular user and the particular section.

In certain aspects, providing a switch offer to the particular user to switch a ticket of the particular user with a ticket held by one of the one or more of the multiple users in the particular section includes determining a value of the ticket of the particular user, determining a value of the ticket of the first user, and determining that a difference between the value of the ticket of the particular user and the value of the ticket of the first user satisfies a switch criteria. In some aspects, determining that a difference between the value of the ticket of the particular user and the value of the ticket of the first user satisfies a switch criteria includes determining that the value of the ticket of the first user is either greater than the value of the ticket of the particular user or matches the value of the ticket of the particular user.

In some implementations, determining a value of the ticket of the particular user includes determining a next switch time for the first user to switch seats and determining the value of the ticket of the particular user based on the next switch time. In certain aspects, determining a next switch time for the first user to switch seats includes determining which ends of playing periods that users are to switch seats, determining a current playing period of the event, and determining, based on the current playing period, the next switch time as the end of playing period that users are to switch seats that is closest to occurring. In some aspects, determining a next switch time for the first user to switch seats includes determining a time remaining in a current playing period of the event, determining that the time remaining in the current playing period of the event satisfies a time criteria, and determining the end of the current playing period as the next switch time.

In certain aspects, determining a next switch time for the first user to switch seats includes determining a time remaining in a current playing period of the event, determining that the time remaining in the current playing period of the event does not satisfy a time criteria, and determining the end of a next playing period as the next switch time. In some implementations, determining a value of the ticket of the particular user is based on at least one of a current score of the event, weather at the venue, time remaining for the event, or demand for seats in the section. In some aspects, actions include providing a request for a switch confirmation to the particular user, receiving the switch confirmation, providing the ticket of the particular user to the first user, and providing the ticket of the first user to the particular user.

Details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of an example system that switches tickets during an event.

FIGS. 2A and 2B are example graphical user interfaces for requesting a switch.

FIG. 3 is an example graphical user interface for confirming to request a switch.

FIG. 4 is an example graphical user interface for confirming to switch after the switch offer is accepted by another user.

FIG. 5 is a swim lane diagram that illustrates an example of operations in switching tickets during an event grouped by entity.

FIG. 6 is a flow diagram that illustrates an example of a process of switching tickets.

FIG. 7 is a block diagram of computing devices that may be used to implement the systems and methods described in this document, as either a client or as a server or plurality of servers.

Like reference symbols in the various drawings indicate like elements.

### DETAILED DESCRIPTION

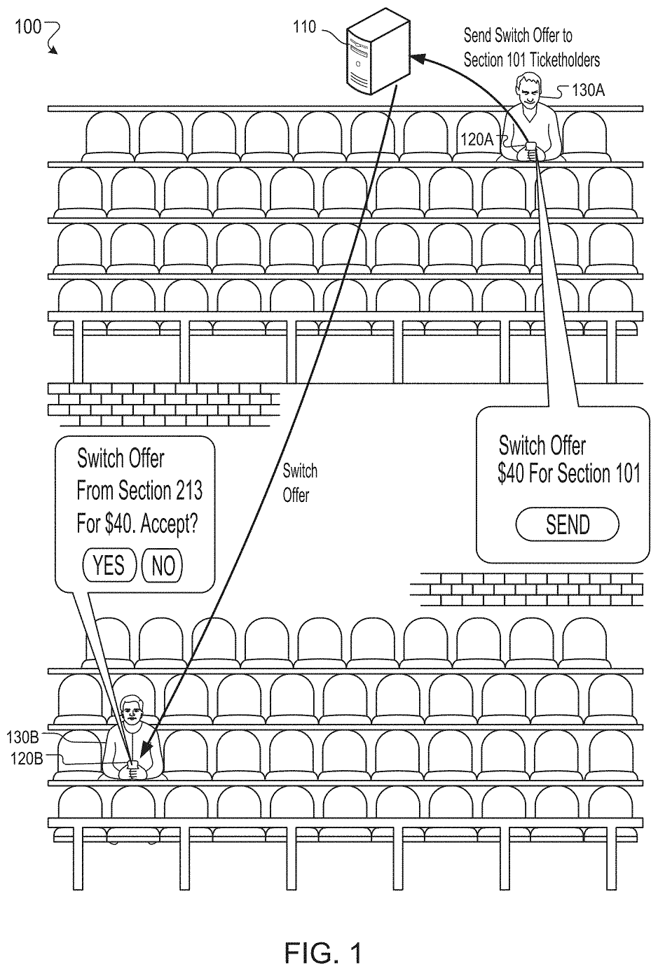

FIG. 1 is a block diagram of an example system 100 that switches tickets during an event.

The system 100 may allow users that want a better or different view of the event to switch with users that also want a different view of the game or are willing to have a worse view of the event if they are compensated. For example, a user that paid for a very close seat in section 101 may be tired of watching a baseball game and be happy to take $40 to switch seats with another user that wants a better seat and is farther back in section 213. In another example, a user that won free tickets for a seat in section 101 may be happy to receive $40 by switching seats with another user that is in a worse seat in section 213.

The system 100 includes a server 110 that switches tickets between users 130A, 130B (collectively referred to as 130) with user devices 120A, 120B (collectively referred to as 120) used by the users 130. The server 110 may be one or more computing devices that are located remotely from a venue hosting the event and that are in communication with the user devices 120. For example, the server 110 may communicate with the user devices 120 through the Internet. The user devices 120 may be mobile computing devices that are carried by the users 130.

As shown in FIG. 1, in an example, the user 130A has a ticket in section 213 and uses the user device 120A to request to switch tickets with any user in section 101. The server 110 receives the request from the user device 120A and sends a switch offer to the user device 120B of the user 130B, where the switch offer prompts whether the user 130B would like to switch tickets with a user in section 213 for a reward of $40.

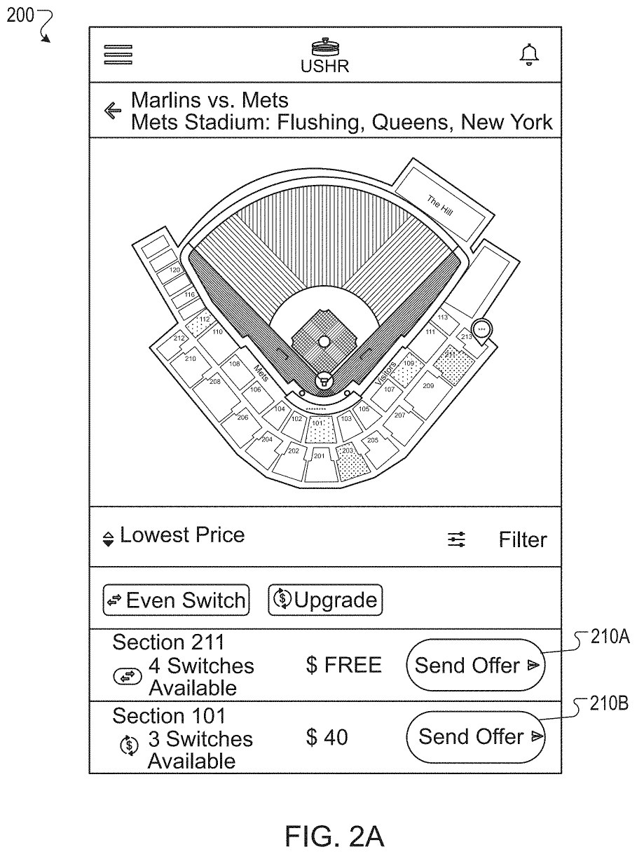

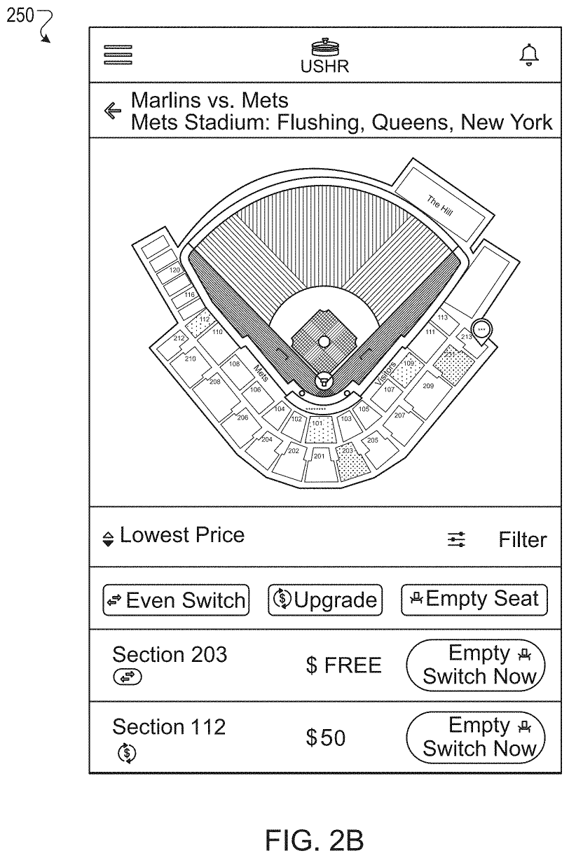

FIGS. 2A and 2B are example graphical user interfaces 200 and 250 for requesting a switch. The graphical user interfaces 200 and 250 may be displayed on the user device that is used by a user that selects whether to send a switch offer to another user. For example, referring back to FIG. 1, the graphical user interfaces 200 and 250 may be displayed on the user device 120A used by the user 130A.

The graphical user interface 200 displays sections that a user may request to be seated in. For example, the graphical user interface 200 displays the user may request to switch into section 211 for free if any of four users in that section accepts the switch offer, and displays the user may request to switch into section 101 by paying $40 if any of three users in that section accepts the switch offer. The graphical user interface 200 includes graphical interface elements that users may select to request to switch tickets. For example, a user may select the button 210A to request to switch into section 211 and may select the button 210B to request to switch into section 101.

The graphical user interface 250 displays sections with empty seats that a user may switch into. For example, the graphical user interface 250 displays that the user may request to switch into section 203 for free as there is at least one empty seat in that section (so the system 100 does not need to wait for another user to accept the switch offer). In the example, the graphical user interface 250 additionally displays that the user may request to switch into section 112 by paying $50 as there is at least one empty seat in that section. While requests for empty seats and non-empty seats are shown in separate graphical user interfaces 200 and 250, a single graphical user interface may display switch requests that may be sent for both empty seats and non-empty seats.

In some implementations, the graphical user interface 200 that requests tickets in sections instead of a specific ticket may be used, as requesting tickets in a section may provide a more user friendly experience than requesting specific tickets. For example, a user at an event may be limited to using a mobile computing device with a small display and have difficulty viewing and selecting from tens or hundreds of individual tickets.

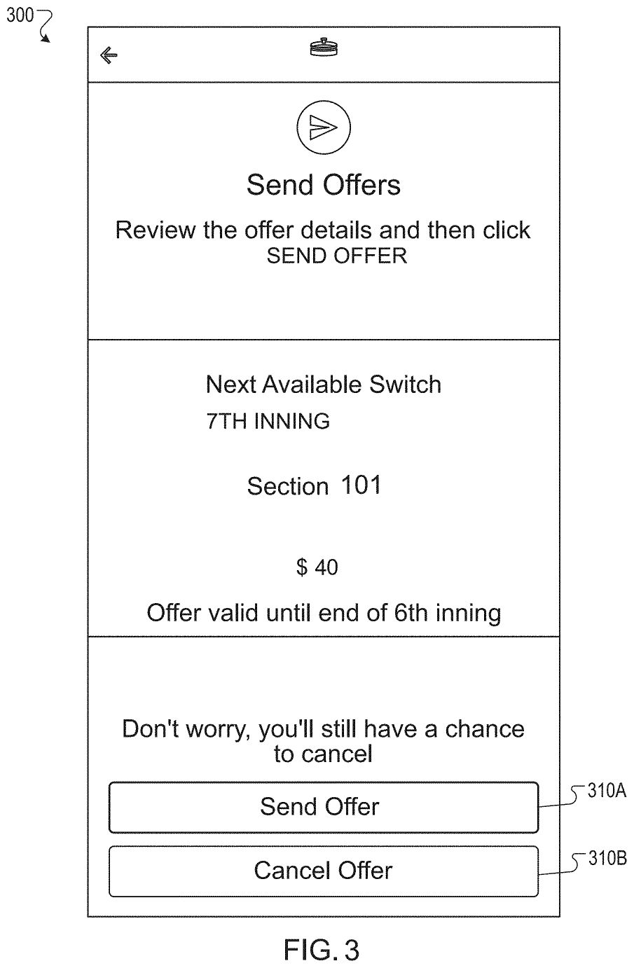

FIG. 3 is an example graphical user interface 300 for confirming to request a switch. The graphical user interface 300 may be shown after a user selects to send a switch offer. For example, the graphical user interface 300 may be shown after a user selects the button 2106 shown in FIG. 2A.

The graphical user interface 300 indicates that the next switch time is during the 7^{th} inning after the 6^{th} inning ends. The next switch time may be the next upcoming time that the ticket holders should begin physically moving to switch seats. The graphical user interface 300 includes graphical interface elements that users may select to confirm to send the switch offer or cancel sending the switch offer. For example, a user may select the button 310A to confirm to send the switch offer and select the button 3106 to cancel sending the switch offer.

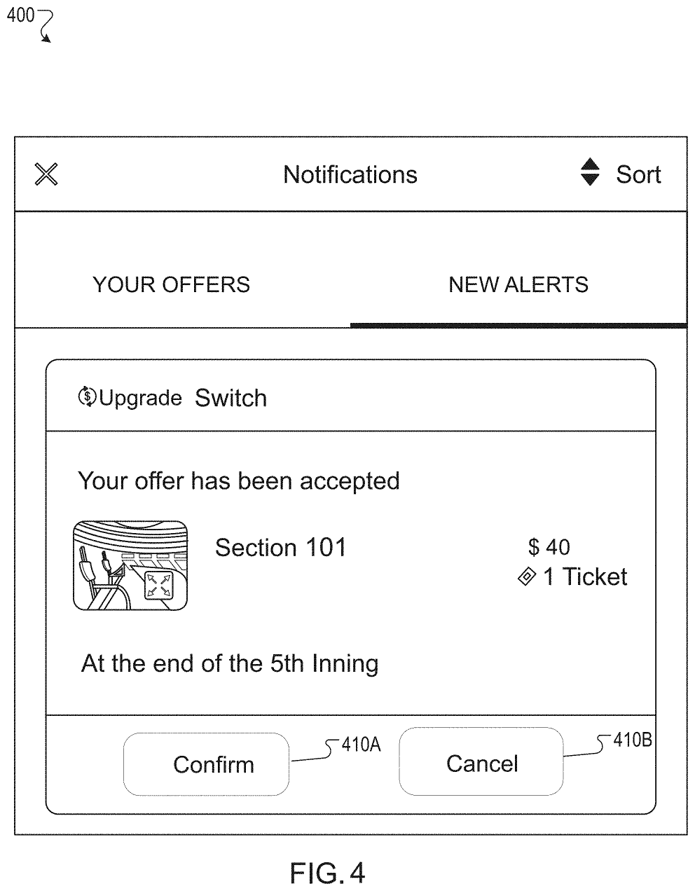

FIG. 4 is an example graphical user interface 400 for confirming to switch after the switch offer is accepted by another user. For example, the graphical user interface 400 may be shown on the user device 120A after the user 130A confirms to send the switch offer to users with tickets in section 101 and after the user 130B accepts the switch offer. The graphical user interface 400 includes graphical interface elements that users may select to confirm the accepted switch offer. For example, the user 130A may select the button 410A to confirm to switch tickets with the user 130B that accepted the switch offer and select the button 410B to cancel the accepted switch offer.

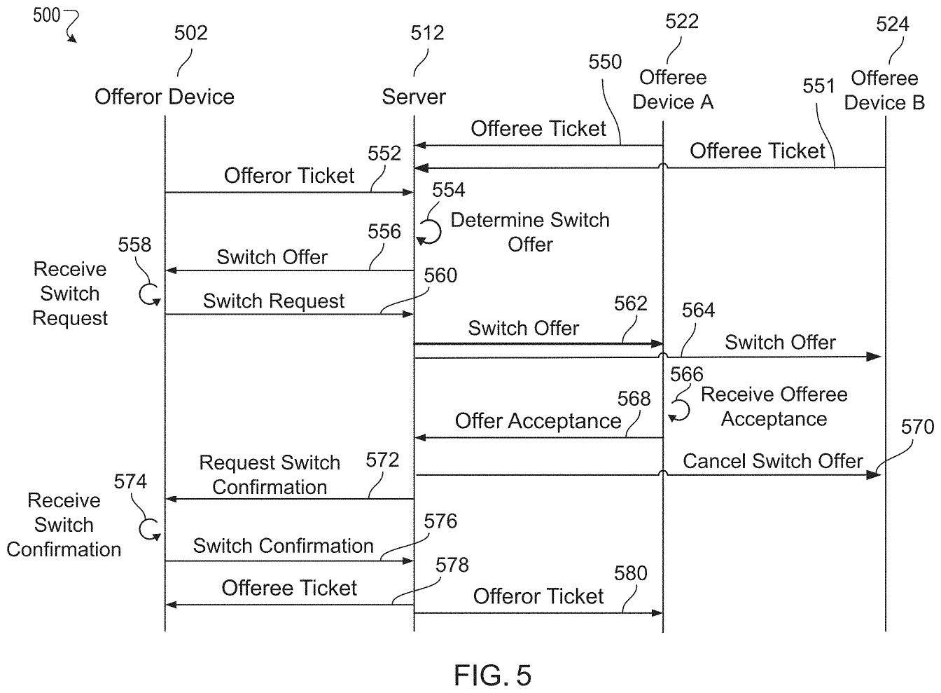

FIG. 5 is a swim lane diagram 500 that illustrates an example of operations in switching tickets during an event grouped by entity. The swim lane diagram shows the operations between an offeror device 502, a server 512, an offeree device A 522, and an offeree device B 524. In some implementations, the offeror device 502 may be the user device 120A, the server 512 may be the server 110, the offeree device A 522 may be the user device 120B, and the offeree device B 524 may be another user device of another user in section 101.

The offeror and offeree devices 502, 522, 524 provides ticket information to the server 512 (550 and 552). For example, during the event, users may provide an image of their tickets to the server 512 or provide input that specifies a section of their ticket. The offeror and offeree devices 502, 522 and 524 may provide the ticket information through an installed mobile application that is designed for switching tickets or through an installed web browser. The server 512 receives the ticket information and stores the ticket information.

Based on receiving ticket information, the server 512 may determine switch offers (554). For example, the server 512 may determine, from the stored ticket information, that ticket information was previously received for two users in section 101 and that ticket information was just received for a user in section 213 and, in response, determine to provide the user in section 213 a switch offer to switch tickets with a user in section 101 for $40.

The server 512 provides the switch offer that was determined to the offeror device 502 (556). For example, the server 512 may provide a switch offer to the user to switch their ticket in section 213 with a ticket of another user in section 101 for $40 provided by the user to the other user.

The offeror device 502 receives a switch request from the user of the offeror device (558). For example, the offeror device 502 may display the graphical user interface 200, then receive a selection of button 210B, then display the graphical user interface 300, and then receive a selection of button 310A.

The offeror device 502 provides the switch request to the server 512 (560). For example, the offeror device 502 transmits an acceptance of the switch offer or an indication to switch with section 101.

The server 512 receives the switch request (560) and, in response, provides the switch offer to the offeree device A 522 (562) and the offeree device B 524 (564). For example, the server 512 provides a switch offer to switch tickets with a ticket in section 213 for a payment of $40 to all the users that provided ticket information for tickets in section 101. The server 512 may provide the switch offer to all users with available tickets in the section as the server does not know which, if any of the users will accept the offer.

The offeree device A 522 receives an offeree acceptance (566). For example, the offeree device A may display a graphical user interface with a prompt asking whether a user accepts the switch offer and receive a selection from the user to accept the switch offer.

The offeree device A 522 provides the offer acceptance to the server 512 (568). For example, offeree device A 522 transmits an acceptance and an identifier of the switch offer that was accepted. In some implementations, once the server 512 receives an acceptance of a switch offer from another user, the server 512 may reserve the ticket of the user that accepted so that the user is not provided further switch offers until the ticket is unreserved.

The server 512 provides a cancellation of the switch offer to the offeree device B 524 (570). The server 512 may cancel the other switch offers as the acceptance of any user within a particular section may appear the same to the offeror as the offeror does not see a row or seat number of the ticket. Additionally, canceling the switch offers may increase availability of tickets for switches by preventing more than one user in the particular section from having their ticket reserved for a switch request.

The server 512 provides a request for a switch confirmation to the offeror device 502 (572). For example, the server 512 may provide the graphical user interface 400 for display on the offeror device 502. In some implementations, the offeror may be asked to confirm an accepted switch offer as the offeror may have requested to switch with multiple sections and may want to attempt to wait for an acceptance from another section the offeror prefers more.

However, to prevent an offeree's ticket from being reserved for too long, acceptances of switch offers may expire after a predetermined amount of time, e.g., two minutes, five minutes, or some other length of time, after which the offeree ticket is unreserved. Accordingly, if an acceptance from a more preferred section is not received before the accepted switch offer expires, an offeror may be incentivized to confirm the accepted switch offer before that offer expires.

The offeror device 502 receives a switch confirmation (574). For example, the offeror device 502 may receive a selection of the button 410A.

The offeror device 502 provides the switch confirmation to the server 512 (576). For example, the offeror device 502 transmits a switch confirmation of the accepted switch offer to the server 512.

The server 512 receives the switch confirmation and provides the offeree ticket to the offeror device 502 (578) and the offeror ticket to the offeree device A 522 (580). For example, the server 512 may provide an image of the offeror ticket to the offeree device A 522 and an image of the offeree ticket to the offeror device 502. In some implementations, the server 512 may provide the images after the server 512 verifies that payment associated with the switch offer is successfully completed.

In some implementations, if the server 512 receives an indication that the accepted switch offer is declined from the offeror device 502, the server 512 may unreserve the ticket of the offeree so that the offeree may receive additional switch offers. In some implementations, when an offeree ticket is unreserved, whether by an explicit decline or expiration, the server 512 may send switch offers to the offeree that the offeree would have received if the offeree ticket were previously unreserved.

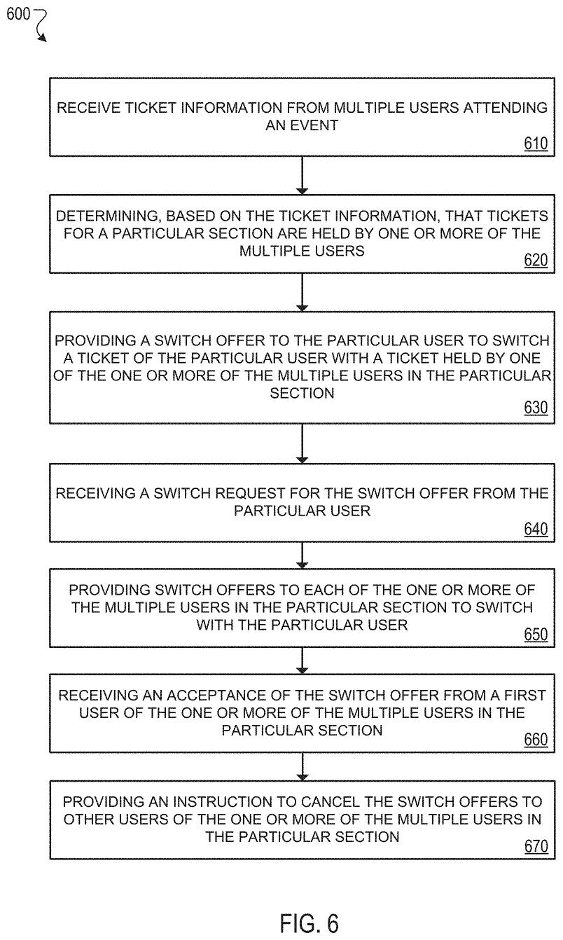

FIG. 6 is a flow diagram that illustrates an example of a process 600 of switching tickets. The process 600 may be performed by one or more computing systems, such as the system 100 shown in FIG. 1 or those shown in FIG. 5.

The process 600 includes receiving ticket information from multiple users attending an event, the ticket information including information from a particular user (610). For example, the server 512 may separately receive ticket information from the offeror device 502, offeree device A 522, and offeree device B 524.

The process 600 includes determining, based on the ticket information, that tickets for a particular section are held by one or more of the multiple users, the one or more multiple users being different from the particular user (620). For example, the server 512 may determine that the ticket information from offeree device A 522 and offeree device B 524 both correspond to tickets in section 101.

In some implementations, determining, based on the ticket information, that tickets for a particular section are held by one or more of the multiple users includes determining from the ticket information from the first user that the first user holds a first ticket for the particular section, and determining from the ticket information from a second user that the second user holds a second ticket for the particular section. For example, the server 512 may determine that the user of offeree device A 522 has a ticket in section 101 and determine that the user of offeree device B 524 also has a ticket in section 101.

In some implementations, determining from the ticket information from the first user that the first user holds a first ticket for the particular section includes determining the particular section from optical character recognition on an image of the first ticket. For example, the server 512 may receive an image of a ticket captured by the offeree device A 522 and recognize text of “section” and “101” on the ticket that specifies that the ticket is for section 101.

In some implementations, determining from the ticket information from the first user that the first user holds a first ticket for the particular section includes determining the particular section from textual input from the first user that specifies the particular section. For example, the server 512 may receive text of “101” that was input by a user of the offeree device A 522 in a textual field labeled “Section.”

The process 600 includes providing a switch offer to the particular user to switch a ticket of the particular user with a ticket held by one of the one or more of the multiple users in the particular section (630). For example, the server 512 may provide a switch offer to the offeror device 502 to switch with a ticket in section 101.

In some implementations, providing a switch offer to the particular user to switch a ticket of the particular user with a ticket held by one of the one or more of the multiple users in the particular section includes determining a section of the ticket of the particular user and determining whether to provide the switch offer to the particular user based on both the section of the ticket of the particular user and the particular section. For example, the server 512 may determine that a ticket of the offeree is in section 213 and determine to provide the switch offer to the offeree based on the section 213 and the section 101 of one or more other tickets.

In some implementations, providing a switch offer to the particular user to switch a ticket of the particular user with a ticket held by one of the one or more of the multiple users in the particular section includes determining a value of the ticket of the particular user, determining a value of the ticket of the first user, and determining that a difference between the value of the ticket of the particular user and the value of the ticket of the first user satisfies a switch criteria. For example, the server 512 may determine a value of the ticket of an offeror as $80, determine a value of the ticket of an offeree as $120, and determine that the different of $40 satisfies a switch criteria.

In some implementations, determining that a difference between the value of the ticket of the particular user and the value of the ticket of the first user satisfies a switch criteria includes determining that the value of the ticket of the first user is either greater than the value of the ticket of the particular user or matches the value of the ticket of the particular user. For example, the server 512 may determine not to provide a switch offer for another ticket in section 395 as that ticket may be valued at $40 while the user's current ticket is valued at $80. The server 512 may not provide the switch offer as users may not send offers to other users to downgrade their own seat.

In another example, the server 512 may determine to provide a switch offer for another ticket in section 211 as that ticket may be valued at $80 which matches the user's current ticket value of $80. The server 512 may provide the switch offer as even though the tickets are valued the same, the user may want a different view of the event. In yet another example, the server 512 may determine to provide a switch offer for another ticket in section 101 as that ticket may be valued at $120 which is greater than the user's current ticket valued at $80. The server 512 may provide the switch offer for tickets of greater value as users may want a better view of the event.

In some implementations, determining a value of the ticket of the particular user includes determining a next switch time for the first user to switch seats and determining the value of the ticket of the particular user based on the next switch time. For example, the server 512 may determine that the next switch time is during the 7th inning after the 6th inning ends, and determine the value of the offeror ticket as $80 based on the next switch time being the 7th inning after the 6th inning ends. In another example, the server 512 may determine that the next switch time is during the 5th inning after the 4th inning ends, and determine the value of the offeror ticket as $120 based on the next switch time being the 3th inning after the 2nd inning ends, which leaves more time to watch the game than the 7th inning after the 6th inning ends.

In some implementations, determining a next switch time for the first user to switch seats includes determining which ends of playing periods that users are to switch seats, determining a current playing period of the event, and determining, based on the current playing period, the next switch time as the end of playing period that users are to switch seats that is closest to occurring. For example, the server 512 may retrieve data that specifies switch times of end of 2^{nd} inning, 4^{th} inning, 6^{th} inning, and 8^{th} inning as switch times for baseball games, determine a current playing period of the event is a middle of the 3^{rd} inning, and determine the next switch time as the end up the 4^{th} inning as the 4^{th} inning is the next soonest switch time.

In some implementations, the server 512 may store different sets of switch times for different types of events. For example, the server 512 may store a set of switch times of end of first quarter, end of second quarter, and end of third quarter labeled to be used with basketball games, store a second set of a single switch time at the end of first half with music concerts, and store a third set of switch times of end of 2nd inning, 4th inning, 6th inning, and 8th inning as switch times for baseball games. In some implementations, the sets of switch times labeled with event type may be specified by a human administrator and stored on the server 512.

In some implementations, determining a current playing period of the event may be based on receiving information from a third party sports information provider. For example, the server 512 may receive, from a third party sports information provider, an indication that there is one out during the 4^{th} inning of a baseball game and a home team is at bat.

In some implementations, determining a next switch time for the first user to switch seats includes determining a time remaining in a current playing period of the event, determining that the time remaining in the current playing period of the event satisfies a time criteria, and determining the end of the current playing period as the next switch time. For example, the server 512 may determine that there is ten minute left in a current quarter, that ten minutes left in the current quarter satisfies a time criteria of at least five minutes remaining in the current quarter, and, in response, determine the end of the current playing period as the next switch time.

In some implementations, determining a next switch time for the first user to switch seats includes determining a time remaining in a current playing period of the event, determining that the time remaining in the current playing period of the event does not satisfy a time criteria, and determining the end of a next playing period as the next switch time. For example, the server 512 may determine that there is one minute left in a current quarter, one minute left that does not satisfy a time criteria of at least five minutes remaining in the current quarter, and, in response, determine the end of the next playing period as the next switch time.

In some implementations, determining a value of the ticket of the particular user is based on at least one of a current score of the event, weather at the venue, time remaining for the event, or demand for seats in the section. For example, the server 512 may determine higher values where scores of different teams are closer as those games may be more exciting. In another example, the server 512 may determine lower values for inclement weather as people may enjoy the event less and be less willing to spend more money. In yet another example, the server 512 may determine higher values where more time is remaining for the event as people may have more time to enjoy the event. In still another example, the server 512 may determine higher values where there is more demand for seats in the section as people may be willing to spend more money for sections in high demand.

The process 600 includes receiving a switch request for the switch offer from the particular user (640). For example, the server 512 may receive, from the offeror device 502, a request to switch tickets with a ticket in section 101.

The process 600 includes providing switch offers to each of the one or more of the multiple users in the particular section to switch with the particular user (650). For example, the server 512 may determine that offeree device A 522 and offeree device B 524 are devices associated with tickets in section 101 and, in response, send switch offers to only those devices based on the switch request.

The process 600 includes receiving an acceptance of the switch offer from a first user of the one or more of the multiple users in the particular section (660). For example, the server 512 may receive an acceptance of the switch offer from offeree device A 522.

The process 600 includes providing an instruction to cancel the switch offers to other users of one or more of the multiple users in the particular section (660). For example, the server 512 may provide an instruction to cancel the switch offer to the offeree device B 524.

In some implementations, the process 600 includes providing a request for a switch confirmation to the particular user, receiving the switch confirmation, providing the ticket of the particular user to the first user, and providing the ticket of the first user to the particular user. For example, the server 512 may provide a switch confirmation request to the offeror device 502, then the server 512 may receive the switch confirmation from the offeror device 502, and then the server 512 may provide the offeror ticket to the offeree device A 522 and provide the offeree ticket to the offeror device 502.

In some implementations, users may indicate whether they want to receive switch offers. For example, the server 512 may store preferences from users that indicate whether the users generally want to receive switch offers, and may receive overrides from users that indicate whether users want to receive switch offers for a particular event. The server 512 may determine whether to provide switch offers to users based on whether the users indicated they want to receive switch offers. For example, the server 512 may initially default users to not receiving switch offers (and not count the users' ticket as available for switch offers), later in the middle of an event users may indicate they want to receive switch offers (and then consider tickets of the users that provided such indications as available for switch offers), and afterwards the users may start receiving switch offers.

In some implementations, the server 512 may automatically expire switch offers based on reaching a next switch time, or being within a few minutes of a next switch time. In some implementations, the server 512 may automatically recalculate values of tickets and resend switch offers to the offeror device 502 and the offeree devices with the recalculated difference in value.

In some implementations, a process may include providing switch offers for individual tickets to a user instead of switch offers for sections. For example, the server 512 may provide switch offers to the offeror device 502 where each of the switch offers identify a respective ticket, e.g., a respective row, a seat number, and section, and a cost, if any, for the switch. The process may include receiving switch requests from the user and providing corresponding switch offers to users that have the individual tickets that were requested. For example, the user of the offeror device 502 may sequentially request multiple switches for individual tickets, and the server 512 may provide a corresponding switch offer to each of the offeree devices of users with those tickets identified by switches that were requested.

The process may include receiving acceptances of the switch offers and providing switch confirmation requests to the user. For example, the server 512 may receive offer acceptances from the offeree devices, and provide a corresponding switch confirmation request to the offeror device 502 for each of the offer acceptances. The process may include receiving a confirmation of a particular offer acceptance, and switching tickets based on the confirmation. For example, the server 512 may receive a confirmation from a user of an accepted switch offer and, in response, provide an image of the user's ticket to the user that accepted the switch offer and provide an image of a ticket of the user that accepted the switch offer to the user. In some implementations, the tickets of users that accepted switch offers may be reserved until the next switch time passes or the user that requested the switch confirms an accepted switch. For example, the server 512 may receive a confirmation of a switch offer from a user and, in response, cancel all reservations of tickets for the user and switch offers that were requested by the user so that the tickets of those users that accepted a switch offer are again available for further switch offers.

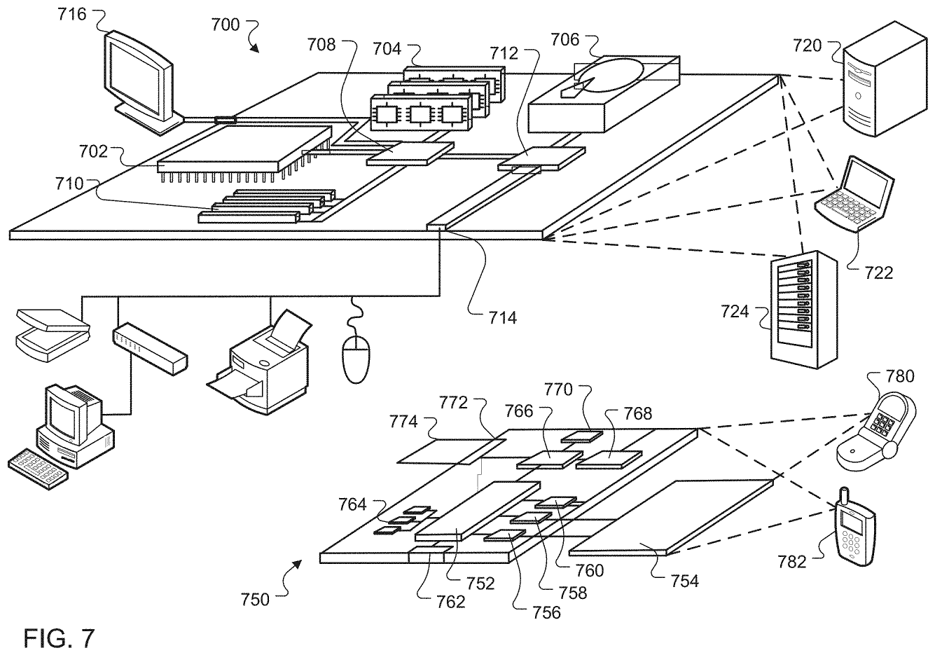

FIG. 7 shows an example of a computing device 700 and a mobile computing device 750 that can be used to implement the techniques described here. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a graphical user interface (GUI) on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provided as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth, WiFi, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In various implementations, operations that are performed “in response” to another operation (e.g., a determination or an identification) are not performed if the prior operation is unsuccessful (e.g., if the determination was not performed). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of embodiments have been described. Nevertheless, it will be understood that various modifications may be made without departing from the scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
receiving ticket information from multiple users attending an event, the ticket information including information from a particular user;
determining, based on the ticket information, that tickets for a particular section are held by one or more of the multiple users, the one or more multiple users being different from the particular user;
providing a switch offer to the particular user to switch a ticket of the particular user with a ticket held by one of the one or more of the multiple users in the particular section;
receiving a switch request for the switch offer from the particular user;
providing switch offers to each of the one or more of the multiple users in the particular section to switch with the particular user;
receiving an acceptance of the switch offer from a first user of the one or more of the multiple users in the particular section; and
providing an instruction to cancel the switch offers to other users of one or more of the multiple users in the particular section.

2. The method of claim 1, wherein determining, based on the ticket information, that tickets for a particular section are held by one or more of the multiple users, the one or more users being different from the particular user comprises:
determining from the ticket information from the first user that the first user holds a first ticket for the particular section; and
determining from the ticket information from a second user that the second user holds a second ticket for the particular section.

3. The method of claim 2, wherein determining from the ticket information from the first user that the first user holds a first ticket for the particular section comprises:
determining the particular section from optical character recognition on an image of the first ticket.

4. The method of claim 2, wherein determining from the ticket information from the first user that the first user holds a first ticket for the particular section comprises:
determining the particular section from textual input from the first user that specifies the particular section.

5. The method of claim 1, wherein providing a switch offer to the particular user to switch a ticket of the particular user with a ticket held by one of the one or more of the multiple users in the particular section comprises:
determining a section of the ticket of the particular user; and
determining whether to provide the switch offer to the particular user based on both the section of the ticket of the particular user and the particular section.

6. The method of claim 1, wherein providing a switch offer to the particular user to switch a ticket of the particular user with a ticket held by one of the one or more of the multiple users in the particular section comprises:
determining a value of the ticket of the particular user;
determining a value of the ticket of the first user; and
determining that a difference between the value of the ticket of the particular user and the value of the ticket of the first user satisfies a switch criteria.

7. The method of claim 6, wherein determining that a difference between the value of the ticket of the particular user and the value of the ticket of the first user satisfies a switch criteria comprises:
determining that the value of the ticket of the first user is either greater than the value of the ticket of the particular user or matches the value of the ticket of the particular user.

8. The method of claim 6, wherein determining a value of the ticket of the particular user comprises:
determining a next switch time for the first user to switch seats; and
determining the value of the ticket of the particular user based on the next switch time.

9. The method of claim 8, wherein determining a next switch time for the first user to switch seats comprises:
determining which ends of playing periods that users are to switch seats;
determining a current playing period of the event; and
determining, based on the current playing period, the next switch time as the end of playing period that users are to switch seats that is closest to occurring.

10. The method of claim 8, wherein determining a next switch time for the first user to switch seats comprises:
determining a time remaining in a current playing period of the event;
determining that the time remaining in the current playing period of the event satisfies a time criteria; and
determining the end of the current playing period as the next switch time.

11. The method of claim 8, wherein determining a next switch time for the first user to switch seats comprises:
determining a time remaining in a current playing period of the event;
determining that the time remaining in the current playing period of the event does not satisfy a time criteria; and
determining the end of a next playing period as the next switch time.

12. The method of claim 1, wherein determining a value of the ticket of the particular user is based on at least one of a current score of the event, weather at a venue, time remaining for the event, or demand for seats in the section.

13. The method of claim 1, comprising:
providing a request for a switch confirmation to the particular user;
receiving the switch confirmation;
providing the ticket of the particular user to the first user; and
providing the ticket of the first user to the particular user.

14. A system comprising:
one or more computers and one or more storage devices storing instructions that are operable, when executed by the one or more computers, to cause the one or more computers to perform operations comprising:
receiving ticket information from multiple users attending an event, the ticket information including information from a particular user;
determining, based on the ticket information, that tickets for a particular section are held by one or more of the multiple users, the one or more multiple users being different from the particular user;
providing a switch offer to the particular user to switch a ticket of the particular user with a ticket held by one of the one or more of the multiple users in the particular section;
receiving a switch request for the switch offer from the particular user;
providing switch offers to each of the one or more of the multiple users in the particular section to switch with the particular user;
receiving an acceptance of the switch offer from a first user of the one or more of the multiple users in the particular section; and
providing an instruction to cancel the switch offers to other users of one or more of the multiple users in the particular section.

15. The system of claim 14, wherein determining, based on the ticket information, that tickets for a particular section are held by one or more of the multiple users, the one or more users being different from the particular user comprises:
determining from the ticket information from the first user that the first user holds a first ticket for the particular section; and
determining from the ticket information from a second user that the second user holds a second ticket for the particular section.

16. The system of claim 15, wherein determining from the ticket information from the first user that the first user holds a first ticket for the particular section comprises:
determining the particular section from optical character recognition on an image of the first ticket.

17. The system of claim 15, wherein determining from the ticket information from the first user that the first user holds a first ticket for the particular section comprises:
determining the particular section from textual input from the first user that specifies the particular section.

18. The system of claim 14, wherein providing a switch offer to the particular user to switch a ticket of the particular user with a ticket held by one of the one or more of the multiple users in the particular section comprises:
determining a section of the ticket of the particular user; and
determining whether to provide the switch offer to the particular user based on both the section of the ticket of the particular user and the particular section.

19. The system of claim 14, wherein providing a switch offer to the particular user to switch a ticket of the particular user with a ticket held by one of the one or more of the multiple users in the particular section comprises:
determining a value of the ticket of the particular user;
determining a value of the ticket of the first user; and
determining that a difference between the value of the ticket of the particular user and the value of the ticket of the first user satisfies a switch criteria.

20. A non-transitory computer-readable medium storing instructions executable by one or more computers which, upon such execution, cause the one or more computers to perform operations comprising:
receiving ticket information from multiple users attending an event, the ticket information including information from a particular user;
determining, based on the ticket information, that tickets for a particular section are held by one or more of the multiple users, the one or more multiple users being different from the particular user;
providing a switch offer to the particular user to switch a ticket of the particular user with a ticket held by one of the one or more of the multiple users in the particular section;
receiving a switch request for the switch offer from the particular user;
providing switch offers to each of the one or more of the multiple users in the particular section to switch with the particular user;
receiving an acceptance of the switch offer from a first user of the one or more of the multiple users in the particular section; and
providing an instruction to cancel the switch offers to other users of one or more of the multiple users in the particular section.
